(19) United States
(12) Patent Application Publication
(10) Pub. No.: US 2011/0110079 A1
(43) Pub. Date: May 12, 2011

(54) LIGHT GUIDE ILLUMINATION DEVICE

(76) Inventor: Cheng-Chao Jong, Taoyuan County (TW)

(21) Appl. No.: 12/616,144

(22) Filed: Nov. 11, 2009

(51) Int. Cl. F21V 9/00; F21V 7/07; F21V 1/00; F21V 7/00

(52) U.S. Cl. 362/231; 362/296.05; 362/235; 362/297

(57) ABSTRACT

A light guide illumination device is provided. The light guide illumination device includes a light guide shade configured with a spherical shape. The light guide shade includes a light inputting aperture and a light outputting aperture. The light inputting aperture is adapted for receiving a light emitting unit therein. The light emitting unit is adapted for emitting a light therefrom. The light guide shade has an inner spherical surface serving as a light reflecting surface. The light reflecting surface is adapted for reflecting the light for one or more times and outputting the reflected light out from the light outputting aperture. The outputted light is then projected from the light outputting aperture to the ambient space.

### BACKGROUND OF THE INVENTION

1. Field of the Invention

The present invention relates generally to a light guide illumination device, and more particularly, to a light guide illumination device including a sphere shaped light guide shade. The sphere shaped light guide shade is configured with a light outputting aperture, from where the light emitted by the light guide illumination device can be guided toward a desired direction, thus improving the light outputting efficiency thereof.

2. The Prior Arts

Generally, a typical illumination device is desired for more efficiently guiding an illuminating direction of the light source, and at the same time providing a visual comfort. In order to achieve higher illumination efficiency, a conventional illumination device is usually equipped with a reflecting shade for guiding the light illuminated on the reflecting shade toward a desired direction, so as to reduce the light loss. Therefore, such a conventional illumination device includes a light shade for the direct glare of the outputted light.

Referring to FIG. 1, there is shown a conventional light guide structure. The light guide structure includes a light shade 80. The light shade 80 is substantially trapezoid-shaped, and is positioned correspondingly over light emitting unit 81. The light shade 80 includes a light inputting portion 811 and a light outputting portion 813. The light inputting portion 811 is configured at a side thereof adjacent to the light emitting unit 81, and the light outputting portion 813 is positioned at another side of the light shade 80 opposite to the light inputting portion 811. When the light emitting unit 81 emits a light. The light is projected into the light shade 80 from the light inputting portion 811, and then outputted from the light outputting portion 813 to the ambient space. The light inputting portion 811 is configured with a recess shape adapted for reflecting and deflecting the inputted light for improving the luminance of the outputted light.

Referring to FIG. 2, there is shown a “LED light system for producing white light” which is disclosed in U.S. Pat. No. 6,234,645. The lighting system includes a light shade 90 and at least there light emitting diodes (LED) 91. Each LED 91 emits a visible light with a predetermined wavelength. A fluorescent layer is coated on an inner wall of the light shade 90, for producing a scattering effect of the light emitted by the LEDs 91. In such a way, a uniformed light is obtained.

However, the light shade 90 is only capable of passively scattering the light illuminated thereon, and is incapable of actively directing the light toward a desired direction. As such, the light outputting efficiency of the conventional lighting system is still unsatisfactory, and the conventional lighting system is still much restricted in enhancing the luminance and improving the light outputting efficiency.

### SUMMARY OF THE INVENTION

A primary objective of the present invention is to provide a light guide illumination device. In accordance with the principle of light being scattered and reflected in a spherical body, an output light can be controlled with a certain outputting direction for effectively save the light loss, thus improving the overall light outputting efficiency.

For achieving the foregoing objective, the present invention provides a light guide illumination device. The light guide illumination device includes a light guide shade configured with a spherical shape. The light guide shade includes a light inputting aperture and a light outputting aperture. The light inputting aperture is adapted for receiving a light emitting unit therein. The light emitting unit is adapted for emitting a light therefrom. The light guide shade has an inner spherical surface serving as a light reflecting surface. The light reflecting surface is adapted for reflecting the light for one or more times and outputting the reflected light out from the light outputting aperture. The outputted light is then projected from the light outputting aperture to the ambient space.

The present invention provides a solution for solving the problem of the conventional technology as discussed above. In accordance with the present invention, an improved luminance and light outputting efficiency can be obtained.

### BRIEF DESCRIPTION OF THE DRAWINGS

The present invention will be apparent to those skilled in the art by reading the following detailed description of preferred embodiments thereof, with reference to the attached drawings, in which:

FIG. 1 is a schematic diagram illustrating a conventional light guide structure;

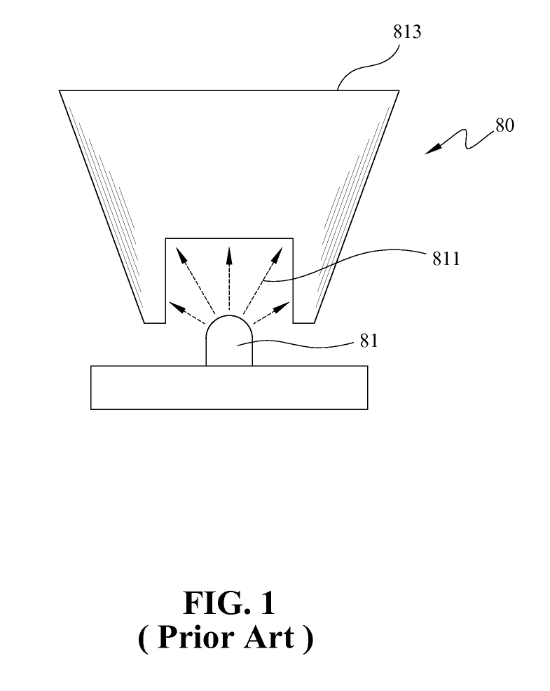

FIG. 2 illustrates a conventional LED light system for producing white light;

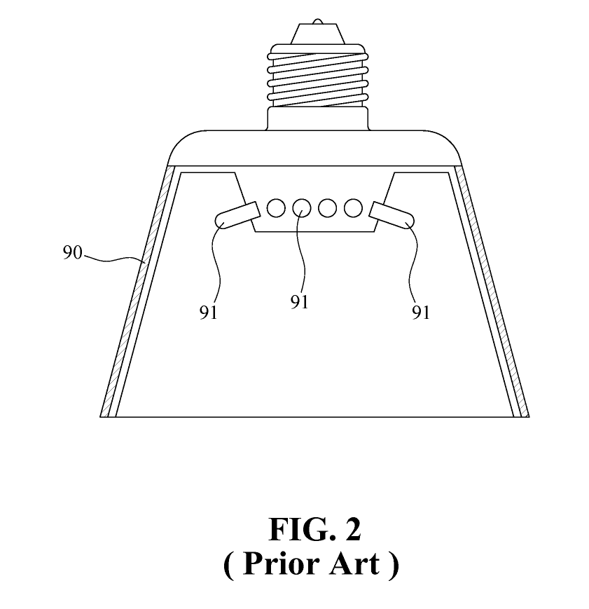

FIG. 3 is a perspective view of a light guide illumination device according to an embodiment of the present invention;

FIG. 4 is a schematic diagram illustrating a light transmitting path of the light guide illumination device of the present invention;

FIG. 5 is a schematic diagram illustrating a light emitting unit of the light guide illumination device of the present invention; and

FIG. 6 is a schematic diagram illustrating a light guide shade of the light guide illumination device of the present invention.

### DETAILED DESCRIPTION OF THE PREFERRED EMBODIMENT

The accompanying drawings are included to provide a further understanding of the invention, and are incorporated in and constitute a part of this specification. The drawing illustrates embodiments of the invention and, together with the description, serves to explain the principles of the invention.

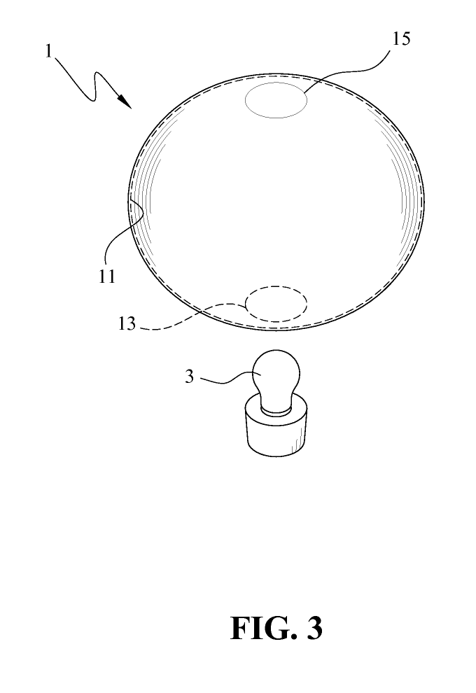

FIG. 3 is a perspective view of a light guide illumination device according to an embodiment of the present invention. Referring to FIG. 3, the present invention provides a light guide illumination device. The light guide illumination device includes a light guide shade 1 and a light emitting unit 3. The light guide shade 1 is hollow sphere shaped having an inner surface serving as a light reflecting surface 11. The light guide shape 1 is configured with a light inputting aperture 13 and a light outputting aperture 15. The light inputting aperture 13 is adapted for receiving a light emitting unit 3 therein. The light emitting unit 3 is adapted for providing an input light therefrom. The light emitting unit 3 includes at least one light emitting diode (LED) unit. An area of the light outputting aperture 15 is determined in accordance with the desired light outputting direction and light outputting range. Preferably, the area of the light outputting aperture 15 is smaller than 1/10 of the area of the entire sphere shaped light guide shade.

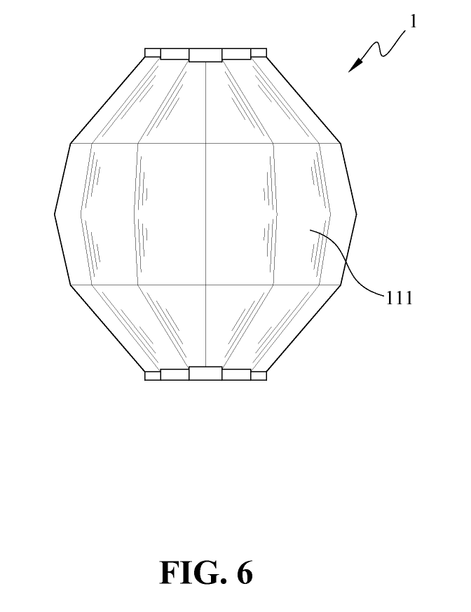

It should be noted that the light guide shade 1 can also be configured with an ellipsoid shape, or any other spherical shape having a curved surface. Further, the light reflecting surface 11 can also be alternatively constituted of a plurality of reflective plane units 111 as shown in FIG. 6.

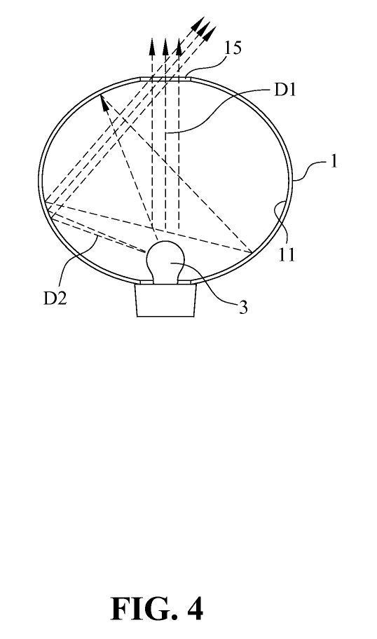

FIG. 4 is a schematic diagram illustrating a light transmitting path of the light guide illumination device of the present invention. Referring to FIG. 4, when the light emitting unit 3 emits the input light. A first part of the input light D1 is directly projected out of the light guide shade 1 from the light outputting aperture 15, and a second part of the input light D2 is reflected for once or many times by the light reflecting surface 11, and finally projected out of the light guide shade 1 from the light outputting aperture 15 to the ambient space. According to an aspect of the embodiment, the light reflecting surface 11 is further provided with a reflective optical film. The area and the shape of the light outputting aperture 15 can be optimally designed, so that the light outputted form the light outputting aperture 15 can be controlled to have a desired outputting angle. And correspondingly, the light loss can be effectively lowered, and the light outputting efficiency can be improved.

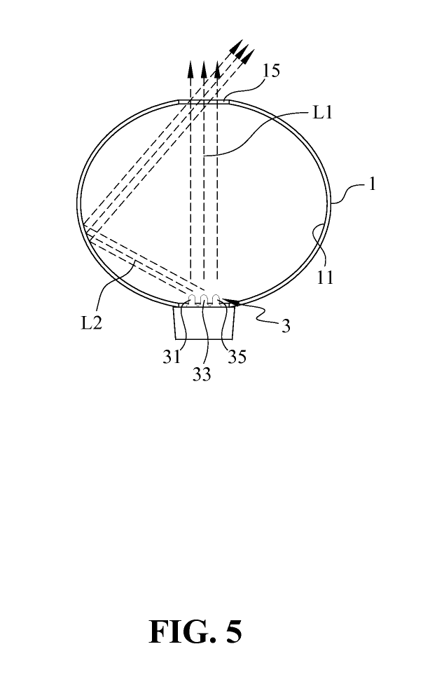

FIG. 5 is a schematic diagram illustrating a light emitting unit of the light guide illumination device of the present invention. Referring to FIG. 5, preferably, the light emitting unit 3 includes a plurality of LED units. The LED units are adapted for emitting lights of different colors, respectively. The lights of different colors are then mixed into the input light. As exemplified in FIG. 5, the light emitting unit 3 includes three LED units 31, 33, and 35. The LED 33 is positioned in the middle and correspondingly in alignment with the light outputting aperture 15. The LEDs 31 and 35 are positioned at two lateral sides of the LED 33. The LED 33 is adapted for emit a white light L1, and the LEDs 31 and 35 are adapted for emitting a yellow light L2. When the LEDs 31, 33, and 35 emit lights at the same time, the white light L1 emitted from the LED 33 is directly outputted from the light outputting aperture 15 to the ambient space, while the yellow light L2 emitted from the LEDs 31 and 35 are reflected for once or many times by the light reflecting surface 11 and thereafter outputted from the light outputting aperture 15 to the ambient space. At the light outputting aperture, the white light L1 and the yellow light L2 are mixed to obtain a warm tone white light for outputting.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A light guide illumination device for generating a concentrated light beam, comprising:
a sphere shaped light guide shade, comprising a light inputting aperture, a light outputting aperture, and an inner surface serving as a light reflecting surface; and
a light emitting unit, received in the light inputting aperture and adapted for emitting an input light, wherein the input light is inputted into the light guide shade from the light inputting aperture, and is reflected for one or more times by the light reflecting surface, and is then outputted from the light outputting aperture to an ambient space.

2. The light guide illumination device according to claim 1, wherein the light emitting unit comprises at least one light emitting diode (LED) unit.

3. The light guide illumination device according to claim 1, wherein the light emitting unit comprises at least one light emitting diode (LED) units and the LED units are adapted for emitting lights of at least two different colors, respectively.

4. The light guide illumination device according to claim 1, wherein the light reflecting surface is constituted of a plurality of plane units.

5. The light guide illumination device according to claim 1, wherein the light reflecting surface is further provided with an optical film.

6. The light guide illumination device according to claim 1, wherein the light outputting aperture has an area at least smaller than 1/10 of an area of the entire sphere shaped light guide shade.
